(19) United States
(12) Patent Application Publication
(10) Pub. No.: US 2022/0386844 A1
(43) Pub. Date: Dec. 8, 2022

(54) DISHWASHING SYSTEM, CONTROL DEVICE AND PROCESS FOR CONTROLLING OPERATION OF A WORK DEVICE

(71) Applicant: Connected Robotics Inc., Tokyo (JP)

(72) Inventor: Tetsuya SAWANOBORI, Tokyo (JP)

(73) Assignee: Connected Robotics Inc., Tokyo (JP)

(21) Appl. No.: 17/889,410

(22) Filed: Aug. 17, 2022

Related U.S. Application Data
(63) Continuation of application No. PCT/JP2021/005306, filed on Feb. 12, 2021.

(30) Foreign Application Priority Data
Feb. 17, 2020 (JP) 2020-024785

(51) Int. Cl. A47L 15/26; A47L 15/42; B25J 11/00

(52) U.S. Cl. CPC A47L 15/26; A47L 15/42; B25J 11/005

(57) ABSTRACT

A control device for a dishwashing system includes processing circuitry configured to control operation of a work device that performs an operation related to a washing rack that is placeable on each of a plurality of support surfaces extending in substantially the same plane, the plurality of support surfaces including a first support surface, a second support surface disposed in association with a dishwasher capable of washing a dish in the washing rack, and a third support surface; and control the work device to operate such that the washing rack is transferred from the first support surface and returned to the first support surface via the second support surface and via the third support surface. A direction in which the washing rack is carried into the dishwasher and a direction in which the washing rack is carried out of the dishwasher form a substantially right angle as viewed from above.

### CROSS-REFERENCE TO RELATED APPLICATIONS

This application is a bypass continuation of and claims priority to PCT/JP2021/005306, filed Feb. 12, 2021, which claims priority to JP 2020-024785, filed Feb. 17, 2020, the contents of each of which is hereby incorporated by reference in their entirety.

### BACKGROUND

Conventionally, a technique has been known in which dishes are washed by a step in which a robot including a robot arm mechanism performs the transfer of a washing rack from a loading stand to a dishwasher and the transfer of the washing rack from the dishwasher to an unloading stand.

### SUMMARY

In accordance with an aspect of the present disclosure, a control device is for a dishwashing system, the control device comprising processing circuitry. The processing circuitry is configured to control an operation of a work device that performs an operation related to a washing rack that is placeable on each of a plurality of support surfaces extending in substantially the same plane, wherein the plurality of support surfaces include a first support surface, a second support surface disposed in association with a dishwasher capable of washing a dish in the washing rack, and a third support surface; and control the work device to operate such that the washing rack is transferred from the first support surface and to be returned to the first support surface via the second support surface and via the third support surface, wherein a direction in which the washing rack is carried into the dishwasher and a direction in which the washing rack is carried out of the dishwasher form a substantially right angle as viewed from above.

### BRIEF DESCRIPTION OF DRAWINGS

FIG. 1 is a block diagram illustrating a configuration of a control device for a dishwashing system.

FIG. 2 is a top view illustrating an example of a workshop in which the control device for a dishwashing system is installed.

FIG. 2A is a perspective view illustrating an example of the workshop.

FIG. 2B is a perspective view illustrating an example of the workshop.

FIG. 2C is a perspective view illustrating an example of the workshop.

FIG. 3 is a perspective view illustrating a hand attached to a distal end of each of a first robot and a second robot.

FIG. 3A is a perspective view illustrating the hand attached to the distal end of the first robot.

FIG. 3B is a perspective view illustrating the hand attached to the distal end of the first robot.

FIG. 3C is a perspective view illustrating the hand attached to the distal end of the first robot.

FIG. 4 is a top view illustrating a configuration of a subrack.

FIG. 4A is a front view illustrating the configuration of the subrack.

FIG. 4B is a side view illustrating the configuration of the subrack.

FIG. 4C is a cross-sectional view of an arm portion taken along line IVc-IVc of FIG. 4.

FIG. 4D is a top view illustrating a configuration of a subrack according to another example.

### DETAILED DESCRIPTION

The inventors have recognized that, when dishes are accommodated in a washing rack and washing is performed by the dishwasher in units of the washing rack, the work of transferring the washing rack, the work of accommodating the dishes used in the washing rack, and the work of extracting the washed dishes from the washing rack needs to be performed. Therefore, in order to efficiently perform the washing of the dishes, the streamlining including the work of transferring the washing rack or the work of conveying the dishes is required.

The inventors have developed the technology discussed in this disclosure to streamline the work of washing a dish as a whole.

A control device for a dishwashing system according to one aspect includes: a processing device that controls an operation of a work device. The work device is capable of performing an operation related to a washing rack that is placeable on each of a plurality of support surfaces extending in substantially the same plane. The plurality of support surfaces include a first support surface, a second support surface disposed in association with a dishwasher capable of washing a dish in the washing rack, and a third support surface. The processing device causes the work device to operate such that the washing rack is transferred from the first support surface to be returned to the first support surface via the second support surface and via the third support surface.

Hereinafter, each embodiment will be described in detail with reference to the accompanying drawings.

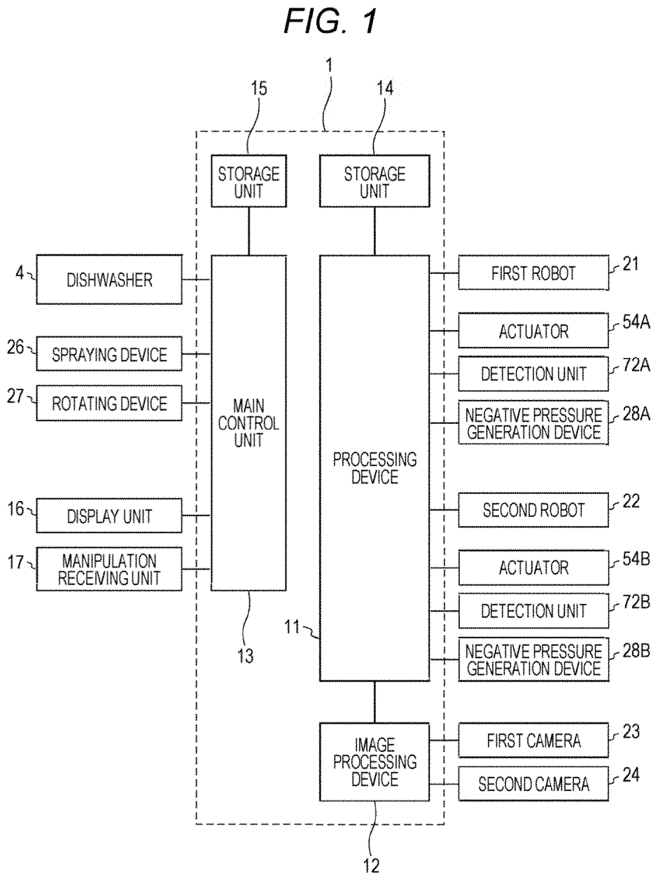

FIG. 1 is a block diagram illustrating a configuration of a control device 1 for a dishwashing system. Incidentally, the control device 1 for a dishwashing system may be realized by one or more computers. In this case, the one or more computers may include a server computer.

As illustrated in FIG. 1, the control device 1 for a dishwashing system includes a processing device 11 that controls the operation of a first robot 21 and a second robot 22 as work devices, an image processing device 12 that processes images of a first camera 23 and a second camera 24 that are attached to the first robot 21 and to the second robot 22, respectively, a main control unit 13 that controls the processing device 11, a dishwasher 4, a spraying device 26, and a rotating device 27, a storage unit 14 that stores a program that defines processing in the processing device 11 and data required for control in the processing device 11, and a storage unit 15 that stores a program that defines processing in the main control unit 13 and data required for control in the main control unit 13. The storage unit 14 and the storge unit 15 may each comprise a memory. Incidentally, the storage unit 14 and the storage unit 15 may be realized by a common storage device or each may be a separate storage device. In addition, the image processing device 12 is, for example, a single graphics processing unit (GPU), but may be realized by a processing device (processing device including a GPU) different from the processing device 11.

The control device 1, processing apparatus 11 and/or main control unit 13 may also be encompassed by or is a component of control circuitry and/or processing circuitry. The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

In addition, a display unit 16 that displays an operating state and the like of the control device 1 for a dishwashing system and a manipulation receiving unit 17 that receives a manipulation by a worker or the like are connected to the main control unit 13.

In addition, the processing device 11 controls an actuator 54A, a detection unit 72A, a negative pressure generation device 28A, an actuator 54B, a detection unit 72B, and a negative pressure generation device 28B to be described later.

The main control unit 13 and the processing device 11 sequentially execute processing required for washing dishes in cooperation with each other.

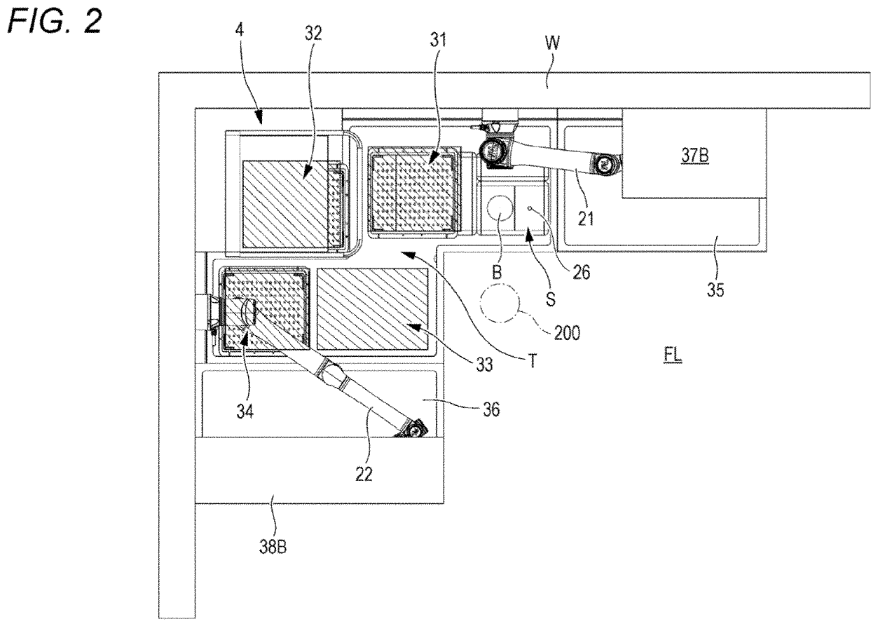

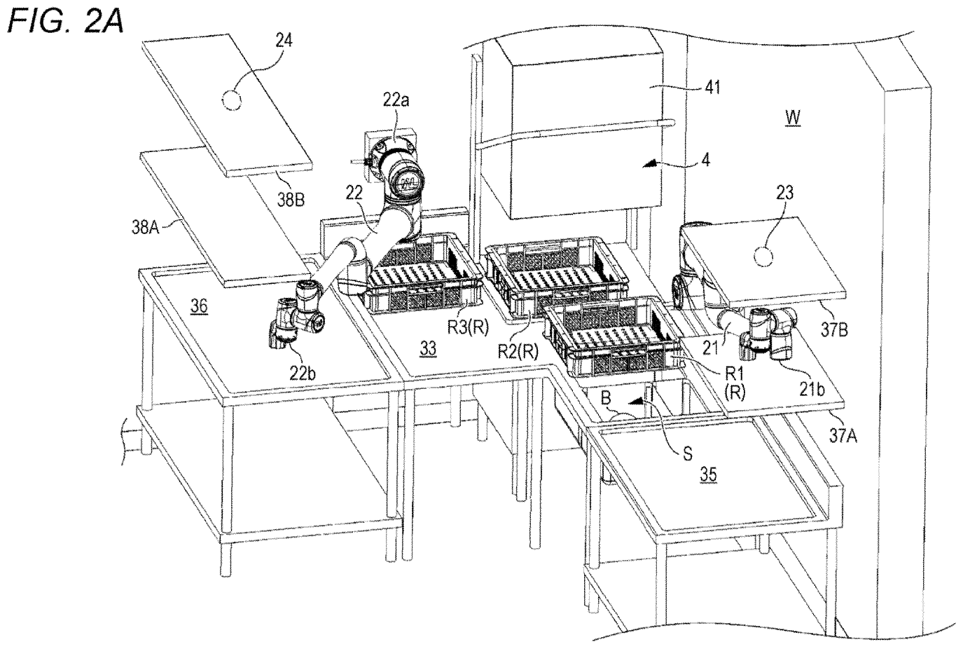

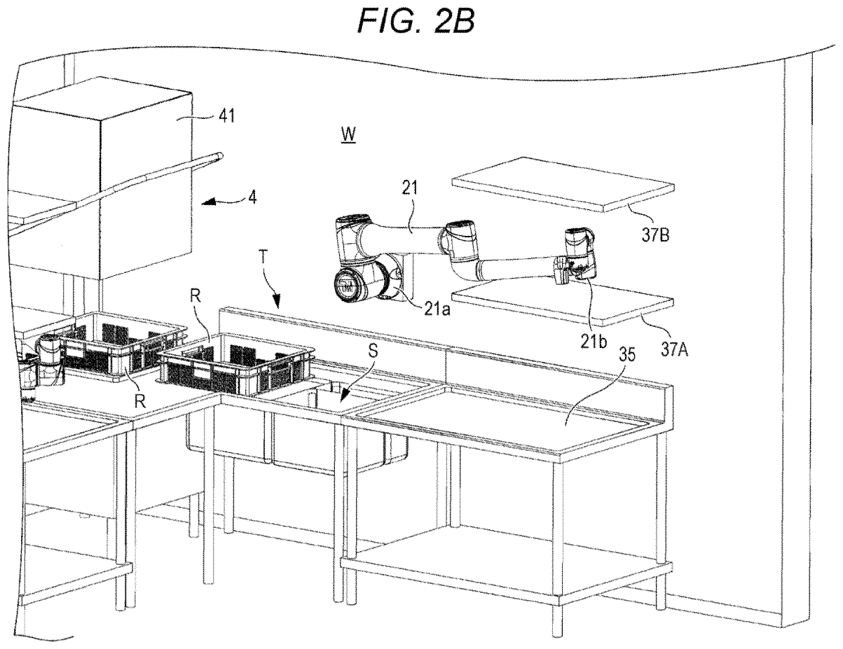

FIG. 2 is a top view illustrating a workshop in which the control device 1 for a dishwashing system is installed, and FIGS. 2A to 2C are perspective views illustrating an example of the workshop. FIG. 2A is a perspective view illustrating the entirety of the workshop, FIG. 2B is a partial perspective view of a side on which dishes to be washed are disposed, and FIG. 2C is an enlarged view of the vicinity of a sink S.

As illustrated in FIG. 2, a work table T having a substantially L shape along a wall W having an L shape is disposed at the workshop. The work table T is provided with a first support surface 31, a second support surface 32, a third support surface 33, and a fourth support surface 34 that extend in substantially the same horizontal plane, and a washing rack R in which dishes are accommodated can be placed on each support surface. In FIG. 2A, as one state, a state where a washing rack R1 is supported on the first support surface 31, a washing rack R2 is supported on the second support surface 32, and R3 is supported on the fourth support surface 34 is illustrated. Incidentally, here, an example is illustrated in which three washing racks R (R1 to R3) are circulated, but the number of the washing racks R to be circulated may be 1 or 2.

Incidentally, each of the first support surface 31 to the fourth support surface 34 may be a support surface capable of supporting the washing rack R, or may be a region that includes a region corresponding to an outer shape of the washing rack R and that is significantly larger than the outer shape. “Extending in substantially the same horizontal plane” means that a step is allowed to the extent of not interfering with the conveyance of the washing rack R by the first robot 21 and the second robot 22 to be described later.

The second support surface 32 is provided at a corner portion of the work table T, and the dishwasher 4 including a washing device 41 to be driven in an up-down direction is installed above the second support surface 32. The first support surface 31, the third support surface 33, and the fourth support surface 34 each are disposed around the second support surface 32. Incidentally, in this case, the first support surface 31 and the fourth support surface 34 are adjacent to the second support surface 32 and to the third support surface 33, respectively.

Each of the first support surface 31 to the fourth support surface 34 may be set on an existing equipment or may be newly provided. Incidentally, a support portion that provides each of the first support surface 31 to the fourth support surface 34 is one example of “the first support portion to the fourth support portion”.

The third support surface 33 can also be formed of a removable table or a storable table. For example, the third support surface 33 can be formed of a table that is removable by being lifted. In this case, a space that stores the removed table may be provided in the work table T. In addition, for example, a table having a substantially rectangular surface may form the third support surface 33, and one side of the substantially rectangular shape may be attached to the work table T through a hinge. In this case, when the third support surface 33 is not needed, the table can be accommodated in a state where the table is suspended through the hinge.

In such a manner, since the third support surface 33 is formed of a removable table or a storable table, a work space of a worker can be expanded. Particularly, there is an advantage that the worker can work at the place of the third support surface 33 in a state where the table is removed or stored.

In addition, the work table T is provided with the sink S for pre-washing dishes, a work table 35 (right side in FIG. 2), and a work table 36 (lower left side in FIG. 2). In addition, a shelf 37A and a shelf 37B are disposed above the work table 35, and a shelf 38A and a shelf 38B are disposed above the work table 36.

The first camera 23 (refer to FIG. 1) is attached to a lower surface of the shelf 37A and/or to a lower surface of the shelf 38A (in FIG. 2A, the first camera 23 attached to the shelf 38A is schematically illustrated by an alternate long and short dashed line). In this case, the first camera 23 can capture an image of a state on the work table 35 from a fixed position. Meanwhile, any position may be selected as the attachment position of the first camera 23 as long as the position allows the first camera 23 to capture an image of a state on the work table 35. In another embodiment, the first camera 23 may be attached to the vicinity of a distal end 21bof the first robot 21. In addition, a plurality of the first cameras 23 may be provided to be able to capture an image of the work table 35 from different points of view.

Incidentally, the first camera 23 is typically monocular but may be a stereo type. In this case, distance information (for example, a height or the like from the work table 35) related to dishes on the work table 35 can also be obtained. In addition, in addition to or instead of the first camera 23, a distance measurement sensor or the like may be used.

In addition, the second camera 24 (refer to FIG. 1) (schematically illustrated by an alternate long and short dashed line in FIG. 2A) is attached to a lower surface of the shelf 38B. In this case, the second camera 24 can capture an image of a state on the shelf 38A from a fixed position. Meanwhile, any position may be selected as the attachment position of the second camera 24 as long as the position allows the second camera 24 to capture an image of a state on the shelf 38A. In another embodiment, the second camera 24 may be attached to the vicinity of a distal end 22b of the second robot 22.

Alternatively, the second camera 24 may be attached to the lower surface of the shelf 38A. In this case, the second camera 24 can capture an image of a state on the work table 36 from a fixed position.

In addition, in another embodiment, a plurality of the second cameras 24 may be provided. For example, the second camera 24 may be provided on each of the lower surface of the shelf 38B and the lower surface of the shelf 38A. Alternatively, the second camera 24 may simultaneously capture images of a state on the shelf 3 8A and a state on the work table 36 from another place.

Similarly to the first camera 23, the second camera 24 is typically monocular but may be a stereo type. In this case, distance information (for example, a height or the like from the shelf 38A and/or from the work table 36) related to dishes on the work table 36 can also be obtained. In addition, in addition to or instead of the first camera 23, a distance measurement sensor or the like may be used.

A recessed portion for storing a washing liquid or water is formed in the sink S, and the recessed portion is provided with the spraying device 26 (FIG. 1) that sprays the washing liquid or the water. In addition, a washing member B (for example, a brush) having a substantially spherical surface is attached to the recessed portion. The washing member B is rotatable around a shaft 28 (FIG. 2C) by the rotating device 27 (FIG. 1), and physically rubs a surface of a dish to wash the dish. Accordingly, an object to be removed having high stickiness, such as rice grains, can be effectively removed from the dish.

As illustrated in FIGS. 2 to 2C, the first robot 21 is installed on one side of the wall W at a height separated from a floor surface FL, and the second robot 22 is installed on another side of the wall W at a height separated from the floor surface FL. In such a manner, since the first robot 21 and the second robot 22 are attached to the wall W, a wide table for the worker can be secured at the workshop. Particularly, in the present embodiment, both the first robot 21 and the second robot 22 are articulated robots, and can be retracted to a wall W side, so that a work space above the table can be effectively secured. In this case, for example, the worker can also work while standing in the vicinity of a region 200 illustrated in FIG. 2, and the equipment can be effectively used even when the first robot 21 and/or the second robot 22 is not in operation.

The first robot 21 and the second robot 22 are articulated robots each including a plurality of rotary joints, and a proximal end 21a and a proximal end 22a thereof are attached to the wall W. Incidentally, as the first robot 21 or the second robot 22, a robot including not only rotary joints but also linear joints can also be used.

In the first robot 21 and the second robot 22, an actuator that drives each joint is provided for each joint, and the actuators are connected to and controlled by the processing device 11.

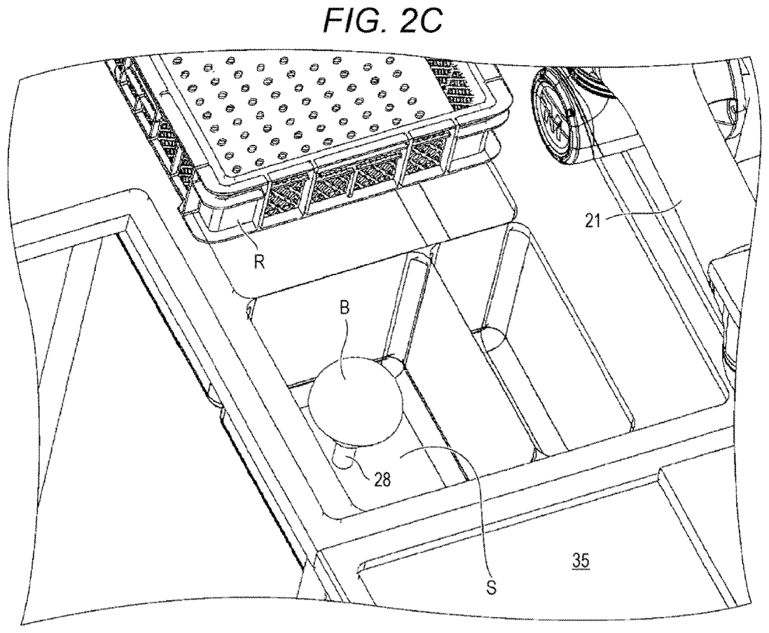

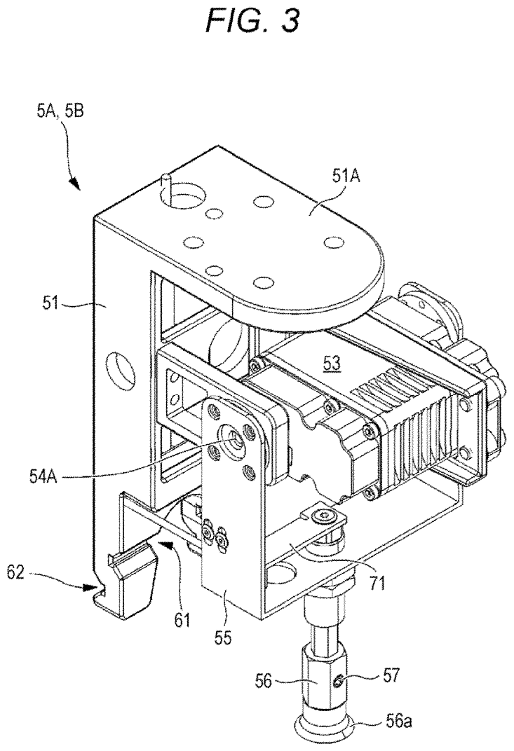

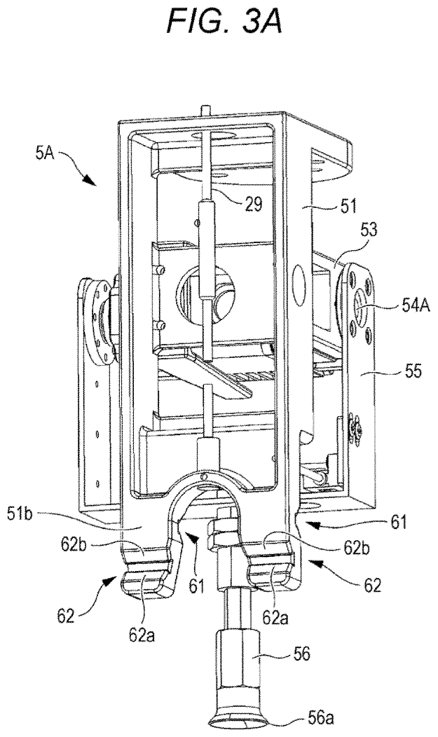

FIG. 3 is a perspective view illustrating a hand 5A and a hand 5B attached to the distal end 21bof the first robot 21 and to the distal end 22b of the second robot 22, respectively. FIGS. 3A to 3C are perspective views illustrating the hand 5A attached to the distal end 21bof the first robot 21. Incidentally, in FIG. 3A, reference sign 29 denotes an electric signal cable.

As illustrated in FIGS. 3 to 3C, the hand 5A includes an abutting member 51 fixed to the distal end 21bof the first robot 21 through an attachment surface 51A (FIG. 3), an actuator portion 53 attached to the abutting member 51, and a support member 55 having a “C” shape that is attached to a rotary shaft 54A of the actuator 54A (FIG. 1) accommodated in the actuator portion 53. The position and the angle of the abutting member 51 are controlled by the processing device 11 through an actuator group of the first robot 21.

In addition, the support member 55 is rotated around the rotary shaft 54A with respect to the abutting member 51 by the driving of the actuator 54A. The position and the angle of the support member 55 are controlled by the processing device 11 through the actuator group of the first robot 21 and through the actuator 54A.

An engagement portion 61 and an engagement portion 62 are formed in the abutting member 51. Incidentally, FIGS. 3 to 3C illustrate an example in which a pair of the engagement portions 61 and a pair of the engagement portions 62 are formed, but the engagement portions may have any configuration. The engagement portions may not form a pair, and the number of the engagement portions may be any number.

In the example of FIGS. 3 to 3C, the engagement portion 61 has an engagement surface 61a and an engagement surface 61bthat form a recessed portion (FIG. 3B). The engagement portion 62 has the same shape as that of the engagement portion 61 and has an engagement surface 62a and an engagement surface 62b that form a recessed portion facing in a direction opposite to that of the recessed portion of the engagement portion 61 (FIG. 3A).

A holding portion 56 that can hold a dish by acting a negative pressure on the dish is attached to the support member 55, the negative pressure being generated by the negative pressure generation device 28A (FIG. 1). The holding portion 56 extending in the up-down direction in FIG. 3 has a pipeline attachment hole 57 extending in a circumferential direction to communicate with the negative pressure generation device 28A. A tube communicating with the negative pressure generation device 28A is airtightly attached to the pipeline attachment hole 57. A filter that prevents foreign matter (for example, rice grains) or moisture from being suctioned toward the negative pressure generation device 28A is provided inside the holding portion 56 communicating with the pipeline attachment hole 57. In addition, the holding portion 56 includes a suction pad 56a which is attached to a distal end (lower end in FIG. 3) side of the holding portion 56 and of which an internal space communicates with the pipeline attachment hole 57. The suction pad 56a is made of an elastic member such as silicone rubber and has a tapered shape in which an inner diameter and an outer diameter increase toward a lower opening end in FIG. 3.

The holding portion 56 is attached to the support member 55 to be slidable in the up-down direction in FIG. 3 and is biased in a down direction in FIG. 3, namely, toward a nominal position by an elastic member such as a spring. Therefore, the holding portion 56 is located at the nominal position in a normal state and is movable to an upper position (position above the nominal position by a predetermined distance) against a biasing force of the elastic member when the holding portion 56 receives a load in an up direction. Incidentally, the further upward movement of the holding portion 56 from the upper position is locked by a stopper. Incidentally, the elastic member such as a spring may be realized by a spring plunger.

In FIG. 3, a light shielding plate 71 formed in an L shape is attached to an upper end side (for example, a distal end portion of the spring plunger) of the holding portion 56 (FIG. 3C). The detection unit 72A using a photo coupler is provided on a distal end portion 71a side (left side in FIG. 3C) of the light shielding plate 71. When the holding portion 56 is at the nominal position, an optical path of the detection unit 72A is blocked by the distal end portion 71a of the light shielding plate 71. When the holding portion 56 reaches the upper position against the biasing force of the elastic member, the distal end portion 71a of the light shielding plate 71 is separated from the optical path of the detection unit 72A.

The hand 5B (FIG. 3) is attached to the distal end 22b of the second robot 22. The hand 5B includes substantially the same configuration as that of the hand 5A, and the hand 5B is provided with the actuator 54B (FIG. 1) instead of the actuator 54A of the hand 5A and with the detection unit 72B (FIG. 1) instead of the detection unit 72A of the hand 5A.

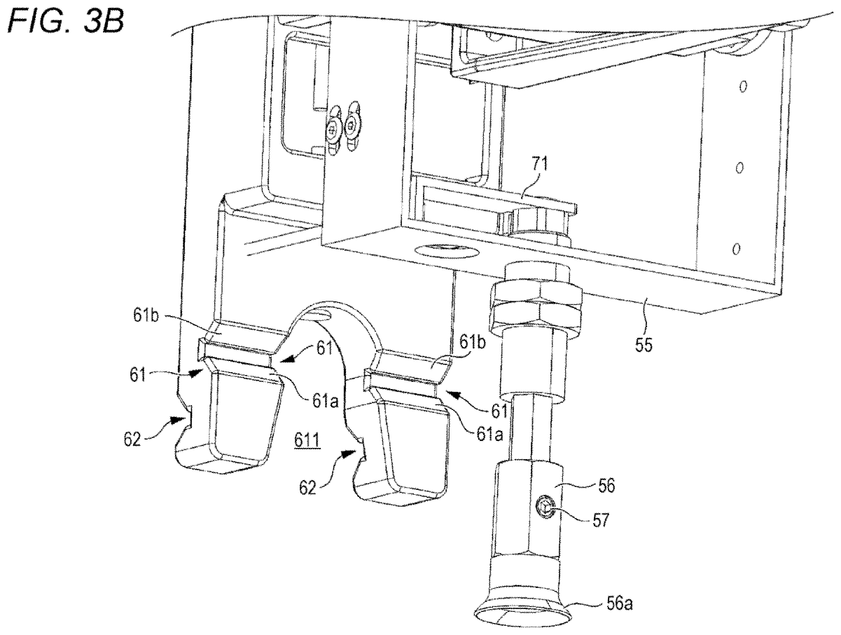

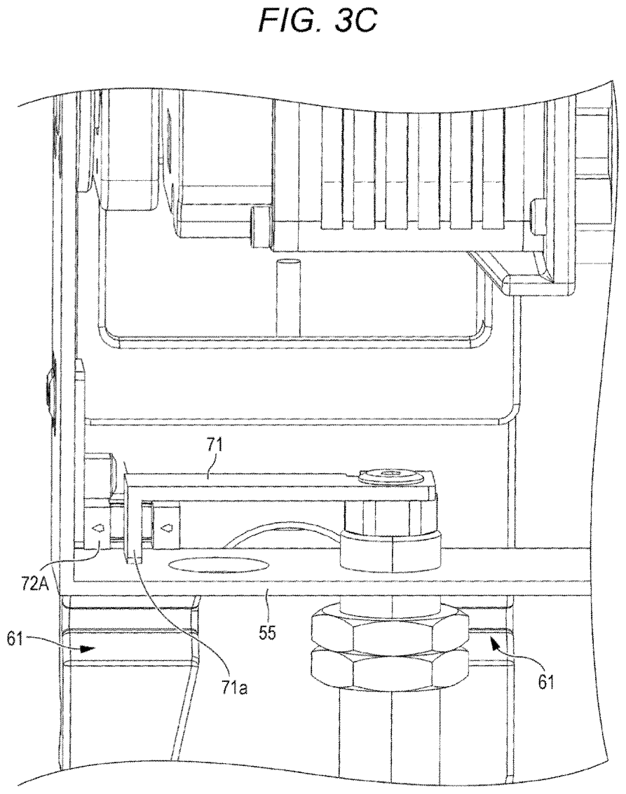

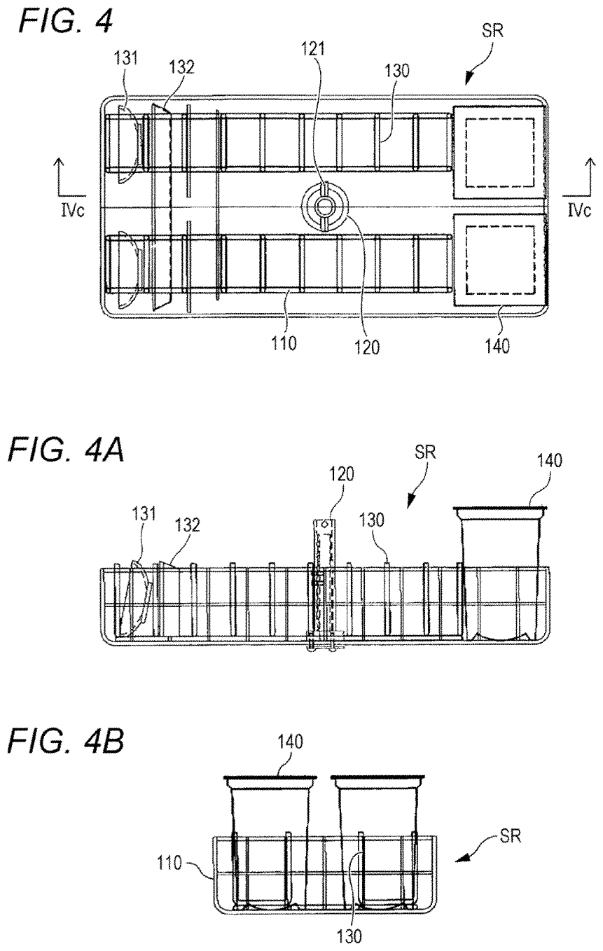

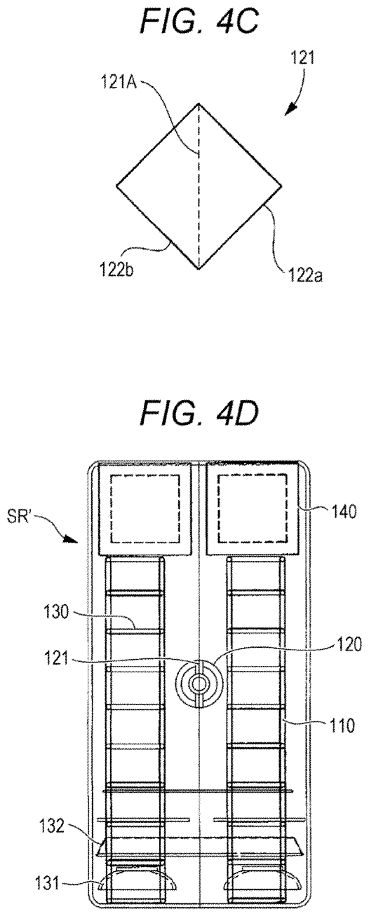

FIG. 4 is a top view illustrating a configuration of a subrack SR, FIG. 4A is a front view illustrating the configuration of the subrack SR, FIG. 4B is a side view illustrating the configuration of the subrack SR, and FIG. 4C is a cross-sectional view of an arm portion 121 taken along line IVc-IVc of FIG. 4.

As illustrated in FIGS. 4 to 4B, the subrack SR includes a main body portion 110 made of a wire net or the like, a shaft portion 120 standing in the vicinity of the position of the center of gravity of the main body portion 110, and the arm portion 121 extending in a horizontal plant so as to intersect the shaft portion 120. Incidentally, the arm portion 121 may be in the form of a pair of protrusions protruding from the shaft portion 120. In addition, in a modification example, the shaft portion 120 may be provided at a position significantly separated from the position of the center of gravity of the main body portion 110.

As illustrated in FIG. 4C, the arm portion 121 has a substantially rectangular cross-sectional shape when cut perpendicularly to an extending direction of the arm portion 121, and a straight line 121A that is one of diagonal lines of the substantially rectangular shape is a vertical line. In addition, the arm portion 121 has an engagement surface 122a and an engagement surface 122b corresponding to two sides of the substantially rectangular shape.

As illustrated in FIGS. 4 to 4B, the main body portion 110 of the subrack SR can also accommodate a partition structure 130, a partition structure 140, and the like. For example, a small plate 131 or a large plate 132 can be supported on the main body portion 110 by means of the partition structure 130. In addition, for example, tableware such as chopsticks, spoons, and forks can be supported on the main body portion 110 by means of the partition structure 140. The subrack SR can be placed in the washing rack R in a state where dishes are put in the subrack SR.

Since the subrack SR can be used, dishes or the like that are too small to be directly placed in the washing rack R (one example of a second-class dish) can be placed in the subrack SR, so that various dishes can be handled. Incidentally, relatively large dishes (for example, a donburi bowl, a bowl, and the like) (one example of a first-class dish) can be directly placed in the washing rack R.

Incidentally, in the example of FIGS. 4 to 4B, the arm portion 121 extends parallel to a lateral direction of the subrack SR, but is not limited thereto. For example, in a subrack SR′ illustrated in FIG. 4D, the arm portion 121 extends parallel to a longitudinal direction of the subrack SR′. In this case, the stability of the subrack SR when being suspended is increased, and the transportability by the first robot 21 or the second robot 22 is improved as compared to a case where the arm portion 121 extends parallel to the lateral direction of the subrack SR.

Next, an operation of the control device 1 for a dishwashing system will be described.

When the worker places a dish used, for example, a plate or a donburi bowl (hereinafter, represented by a “plate”) on the work table 35, the shelf 37A, or the shelf 37B with the dish used facing down, the processing device 11 controls the first robot 21 such that the first robot 21 holds the plate through the holding portion 56 of the hand 5A.

Specifically, the processing device 11 specifies the existence of a specific type of a plate and a position of the plate according to a recognition result of the image processing device 12 based on an image captured by the first camera 23. In addition, the processing device 11 causes the holding portion 56 to move to above the position of the specified plate and causes the holding portion 56 (suction pad 56a) to approach a bottom surface of the plate while maintaining a state where an extending direction of the holding portion 56 is vertically aligned. When the suction pad 56a has come into contact with the plate and then the holding portion 56 further descends, the holding portion 56 receives a force from the plate in the up direction and moves upward with respect to the support member 55 against the biasing force of the elastic member. As described above, when the holding portion 56 reaches the upper position, the distal end portion 71a of the light shielding plate 71 is separated from the optical path of the detection unit 72A, and the detection unit 72A detects that the holding portion 56 has reached the upper position. The processing device 11 stops the descending operation of the holding portion 56 at a timing when the detection unit 72A detects that the holding portion 56 has reached the upper position. Since the suction pad 56a is pressed against the bottom surface of the plate with an appropriate force by such control of the processing device 11, the plate is stably held by the suction force of a negative pressure generated by the negative pressure generation device 28A (FIG. 1). In addition, the holding portion 56 can be prevented from being pressed against the plate with an excessive force.

Next, the processing device 11 causes the plate to move to a position close to the spraying device 26 (FIG. 1) of the recessed portion of the sink S in a state where the extending direction of the holding portion 56 is vertically aligned, while maintaining a state where the negative pressure is generated by the negative pressure generation device 28A (FIG. 1). In this state, the processing device 11 causes a washing liquid or the like to be sprayed from the spraying device 26 toward a surface of the plate through control of the main control unit 13.

Next, the processing device 11 causes the plate to move to above the washing member B of the recessed portion of the sink S while maintaining a state where the negative pressure is generated by the negative pressure generation device 28A (FIG. 1). Next, the processing device 11 causes the plate to descend while maintaining a state where the extending direction of the holding portion 56 is vertically aligned. When the plate has come into contact with the washing member B and then the holding portion 56 further descends, the holding portion 56 receives a force from the plate in the up direction and moves upward with respect to the support member 55 against the biasing force of the elastic member. As described above, when the holding portion 56 reaches the upper position, the distal end portion 71a of the light shielding plate 71 is separated from the optical path of the detection unit 72A, and the detection unit 72A detects that the holding portion 56 has reached the upper position. The processing device 11 stops the descending operation of the holding portion 56 at a timing when the detection unit 72A detects that the holding portion 56 has reached the upper position. Since the plate is pressed against the washing member B with an appropriate force by such control of the processing device 11, the plate is efficiently pre-washed by the washing member B that is rotationally driven by the rotating device 27.

Incidentally, when washing by the washing member B is performed, in terms of controlling the position of the plate, the holding portion 56 may be controlled to move to a position defined in advance without using a detection result of the detection unit 72A.

Next, the processing device 11 causes the plate to be transferred to a position where the plate has to be accommodated in the washing rack R placed on the first support surface 31 (FIG. 2), by causing the holding portion 56 to move while maintaining a state where the negative pressure is generated by the negative pressure generation device 28A (FIG. 1). In this state, the processing device 11 eliminates the suction force induced by the negative pressure by stopping the operation of the negative pressure generation device 28A, and places the plate on the washing rack R.

Incidentally, the position where the plate is placed may be determined according to a recognition result of the image processing device 12 based on an image of the washing rack R obtained by the first camera 23, or may be determined based on a history of placing plates or the like in the washing rack R (for example, a history of a placement position or the like).

Next, an operation in which the subrack SR in which dishes are accommodated is placed in the washing rack R placed on the first support surface 31 (FIG. 2) will be described.

When the worker places the subrack SR in which dishes such as used chopsticks, spoons, and forks are accommodated, on the work table 35, the shelf 37A, or the shelf 37B, the processing device 11 controls the first robot 21 such that the first robot 21 hoists the subrack SR through the engagement portions 61 or the engagement portions 62 of the hand 5A.

Specifically, the processing device 11 causes the engagement portions 61 or the engagement portions 62 of the abutting member 51 of the first robot 21 to be located below the arm portion 121 of the subrack SR according to a recognition result of the image processing device 12 based on an image captured by the first camera 23. Next, the processing device 11 causes the abutting member 51 to rise. Accordingly, the engagement portions 61 or the engagement portions 62 and the arm portion 121 of the subrack SR engage with each other. For example, when the engagement portions 61 engage with the arm portion 121 of the subrack SR, portions (a pair of portions) on a shaft portion 120 side of the arm portion 121 engage with the pair of respective engagement portions 61 in a state where the shaft portion 120 passes through a cutout portion 611 (refer to FIG. 3B) between the pair of engagement portions 61. Accordingly, the subrack SR can be stably supported and transported by the abutting member 51 through the shaft portion 120 and through the arm portion 121.

In a state where the engagement portions 61 have engaged with the arm portion 121, the engagement surfaces 61a of the engagement portions 61 and the engagement surface 122a (or the engagement surface 122b) of the arm portion 121 are in contact with each other. In addition, the engagement surfaces 61bof the engagement portions 61 and the engagement surface 122a (or the engagement surface 122b) of the arm portion 121 are in contact with each other. Since these surfaces are in contact with each other, the position of the arm portion 121 with respect to the abutting member 51 in a direction perpendicular to the extending direction of the arm portion 121 (in a right-left direction in FIG. 4C) is accurately defined. Namely, the position of the subrack SR is determined with the same accuracy as the position accuracy of the abutting member 51.

In addition, even though there is an error in the recognized position of the subrack SR, when the abutting member 51 is raised, sliding occurs between the engagement surfaces 61a and the engagement surface 122a (or the engagement surface 122b) or between the engagement surfaces 61band the engagement surface 122a (or the engagement surface 122b), and finally, both the engagement surface 122a and the engagement surface 122b come into contact with both the engagement surfaces 61a and the engagement surfaces 61b. Therefore, the position of the subrack SR with respect to the abutting member 51 is always accurate.

Next, the processing device 11 causes the subrack SR to be placed at a position where the subrack SR has to be accommodated in the washing rack R placed on the first support surface 31 (FIG. 2), by causing the abutting member 51 to move while maintaining a state where the subrack SR is suspended by the abutting member 51 of the first robot 21.

Incidentally, the position where the subrack SR is placed may be determined according to a recognition result of the image processing device 12 based on an image of the washing rack R obtained by the first camera 23, or may be determined based on a history of placing plates, the subrack SR, or the like in the washing rack R (for example, a history of a placement position or the like).

The processing device 11 repeats the above processing until it is determined that the washing rack R placed on the first support surface 31 (FIG. 2) has to be put into the dishwasher 4. Whether or not the washing rack R placed on the first support surface 31 has to be put into the dishwasher 4 may be determined according to a recognition result of the image processing device 12 based on an image of the washing rack R obtained by the first camera 23 and/or the second camera 24, or may be determined based on a history of placing plates or the like in the washing rack R (for example, a history of a placement position or the like).

Next, the processing device 11 causes the abutting member 51 to be linearly driven in a direction of the second support surface 32 (in a left direction in FIG. 2) while causing the abutting member 51 of the first robot 21 to be pressed against the washing rack R (washing rack R placed on the first support surface 31). Accordingly, the washing rack R is transferred from the first support surface 31 in the direction of the second support surface 32. Here, for example, the washing rack R is moved by pressing a surface 51bof the abutting member 51 against an outer surface of a side wall (right side wall in FIG. 2) of the washing rack R and by pushing the outer surface, the surface 51bbeing located on a front side of FIG. 3A.

Next, the processing device 11 causes the dishwasher 4 to operate through control of the main control unit 13.

When a washing step performed by the dishwasher 4 is completed, the operation of the dishwasher 4 is stopped by control of the main control unit 13.

Next, the processing device 11 causes the abutting member 51 to be linearly driven in a direction of the fourth support surface 34 (in a down direction in FIG. 2) while causing the abutting member 51 of the second robot 22 to abut against the washing rack R placed on the second support surface 32. Accordingly, the washing rack R is transferred from the second support surface 32 in the direction of the fourth support surface 34. Here, for example, the washing rack R is moved by pressing the surface 51bof the abutting member 51 against an inner surface of a side wall (lower side wall in FIG. 2) of the washing rack R and by pulling the inner surface, the surface 51bbeing located on the front side of FIG. 3A.

Next, the processing device 11 causes the abutting member 51 to be linearly driven in a direction of the third support surface 33 (in a right direction in FIG. 2) while causing the abutting member 51 of the second robot 22 to abut against the washing rack R placed on the fourth support surface 34. Accordingly, the washing rack R is transferred from the fourth support surface 34 in the direction of the third support surface 33. Here, for example, the washing rack R is moved by pressing the surface 51bof the abutting member 51 against an outer surface of a side wall (left side wall in FIG. 2) of the washing rack R and by pushing the outer surface, the surface 51bbeing located on the front side of FIG. 3A.

Next, the processing device 11 causes plates and the subrack SR placed in the washing rack R placed on the third support surface 33, to be sequentially transferred to the work table 36 and to the shelf 38A and the shelf 38B (one example of a placement portion). Here, as described above, the plate is held and transferred from the washing rack R to, for example, the work table 36 by the holding portion 56. In addition, the subrack SR is suspended through the engagement portions 61 or the engagement portions 62 and is transferred from the washing rack R to, for example, the shelf 38A and the shelf 38B. Incidentally, a sensor that measures a weight of the suspended subrack SR may be provided and a transfer destination may be changed according to the weight of the subrack SR. For example, the subrack SR having a heavy weight and the subrack SR having a light weight may be transferred to the lower shelf 38A and to the upper shelf 38B, respectively. Accordingly, a burden on the worker can be reduced.

Incidentally, the type, the position, and the like of plates placed on the work table 36, the shelf 38A, or the shelf 38B can be identified from a recognition result of the image processing device 12 based on an image obtained by the second camera 24. Therefore, whether a plate is placed on the work table 36, the shelf 38A, or the shelf 38B and a position where the plate is placed on the work table 36, the shelf 38A, or the shelf 38B may be determined according to the recognition result of the image processing device 12 based on the image obtained by the second camera 24. Incidentally, when a lack of a space to place plates is detected based on a recognition result of the image processing device 12 based on an image obtained by the second camera 24, an alarm or the like that urges the worker to move plates may be output.

In addition, plates may be stacked on the work table 36, on the shelf 38A, and on the shelf 38B. In this case, the number of the stacked plates may be limited to a specified value or less according to the types of the plates, a height of a space above a placement portion, or the like.

Incidentally, in the present embodiment, as one example, three of the work table 36, the shelf 38A, and the shelf 38B are used as placement portions, but only any one or two of the work table 36, the shelf 38A, and the shelf 38B may be used as placement portions. In this case, the second camera 24 may be appropriately disposed to be able to capture an image of a state of the placement portions.

Next, the processing device 11 causes the empty washing rack R placed on the third support surface 33, to be transferred to the first support surface 31. Here, for example, the washing rack R is moved by pressing the surface 51bof the abutting member 51 of the second robot 22 against an outer surface of a side wall (lower side wall in FIG. 2) of the washing rack R and by linearly pushing the outer surface in a direction of the first support surface 31 (in an up direction in FIG. 2), the surface 51bbeing located on the front side of FIG. 3A.

As described above, according to the present embodiment, the washing of dishes using the washing rack R can be performed by a cycle in which the washing rack R is transferred in order of the first support surface 31, the second support surface 32, the fourth support surface 34, the third support surface 33, and the first support surface 31. In this cycle, a complicated movement such as the up and down movement of the washing rack R is not needed, and the washing rack R can be efficiently transferred in a short time. For this reason, the washing time including the work of transferring the washing rack R can be shortened.

In addition, according to the present embodiment, since the washing rack R is circulated in order of the first support surface 31, the second support surface 32, the fourth support surface 34, the third support surface 33, and the first support surface 31, the work of lifting the washing rack R for the moment and then setting the washing rack R again and the like are not needed, and efficient work can be realized.

In addition, according to the present embodiment, since the washing rack R is washed by the washing device 41, together with dishes, the washing rack R can be circulated in order of the first support surface 31, the second support surface 32, the fourth support surface 34, the third support surface 33, and the first support surface 31 while maintaining a clean state.

In addition, in the present embodiment, while dishes accommodated in the washing rack R placed on the second support surface 32 are washed by the dishwasher 4, dishes before washing can be conveyed to the washing rack R placed on the first support surface 31, and dishes can be conveyed from the washing rack R placed on the third support surface 33. For this reason, the washing time including the work of conveying dishes can be shortened.

Further, in the present embodiment, since the first support surface 31, the second support surface 32, the fourth support surface 34, and the third support surface 33 are used, a maximum of three washing racks R can be used in sequence. For this reason, while one washing rack R is put inside the dishwasher 4 above the second support surface 32, the time for performing another work (conveyance of dishes or the like) on another washing rack R can be secured. For this reason, the operating time of the dishwasher 4 can be maximized, and dishes can be efficiently washed.

Incidentally, in the present embodiment, the washing rack R in which dishes are placed is transferred using the first robot 21 and the second robot 22, but a part or the entirety of this transfer may be executed by another device. For example, the washing rack R may be transferred by a conveyor device that uses rollers or belts to move the washing rack R. For example, while the conveyor device realizes the transfer of the washing rack R from the third support surface 33 to the first support surface 31, the first robot 21 may realize the transfer of the washing rack R from the first support surface 31 to the second support surface 32, and the second robot 22 may realize the transfer of the washing rack R from the fourth support surface 34 to the third support surface 33.

In addition, the first support surface 31, the second support surface 32, the fourth support surface 34, and the third support surface 33 may be realized by one rotary table. In this case, as described above, the washing rack R can be circulated in order of the first support surface 31, the second support surface 32, the fourth support surface 34, the third support surface 33, and the first support surface 31 by rotating the rotary table.

In the hand 5A and the hand 5B of the present embodiment, the engagement portions 61 and the engagement portions 62 that engage with the subrack SR are formed in the abutting member 51, and a plate can be held through the holding portion 56. For this reason, the hand 5A and the hand 5B that are common to each other can perform the conveyance of the washing rack R, the conveyance of the subrack SR, and the conveyance of a dish such as a plate. For this reason, one hand 5A or hand 5B can perform various works. Therefore, the washing time including the work of conveying dishes can be shortened.

More specifically, according to the present embodiment, the hand 5A and the hand 5B each can perform, as various works, an operation of transferring the washing rack R in which dishes can be placed, from one support surface of the first support surface 31, the second support surface 32, the fourth support surface 34, and the third support surface 33 to another support surface, an operation of picking up a dish and of placing the dish in the washing rack

R, an operation of picking up the subrack SR in which dishes are placed and of placing the subrack SR in the washing rack R, and an operation of picking up a dish from inside the washing rack R and of placing the dish on a placement portion (the work table 36, the shelf 38A, or the like). Accordingly, efficient work can also be realized for various dishes while handing two types of racks such as the washing rack R and the subrack SR.

In addition, in the present embodiment, the subrack SR that can be placed in the washing rack R is used. For this reason, when various types of dishes are accommodated in the subrack SR and the subrack SR is placed in the washing rack R, regardless of the types of the dishes, the dishes can be conveyed by a common work. In addition, even when the number of dishes is increased, the dishes can be conveyed in units of the subrack SR. For this reason, the work of conveying dishes can be simplified and streamlined, and the washing time including the work of conveying the dishes can be shortened.

In addition, according to the present embodiment, since each of the first robot 21 and the second robot 22 is an articulated robot and is installed on the wall W at a height separated from the floor surface FL, a work space of the worker can be effectively secured, for example, as compared to a case where robots that can perform the same work are installed on the floor surface FL (for example, in the region 200 in FIG. 2). Accordingly, collaboration between the person and the robots can be more effectively done, and a system with high convenience can be realized.

Each embodiment has been described above in detail, but the present invention is not limited to a specific embodiment, and various modifications and changes can be made without departing from the scope of the claims. In addition, all or a plurality of the components of the above-described embodiment can also be combined.

For example, in the above-described embodiment, the washing rack R is circulated using four support surfaces such as the first support surface 31 to the fourth support surface 34, but the number of the support surfaces may be any number as long as the number is 3 or more.

In addition, in the above-described embodiment, dishes to be washed are transferred from the first support surface 31 to the third support surface 33 only once, but may be circulated two or more times depending on the degree of dirt or the like.

In addition, one aspect of the above-described embodiment provides the following solutions. In this case, a robot that can work on various dishes in a highly versatile manner can be realized.

(1) There is provided a hand that is mountable in an articulated robot for a dishwashing system, in which the hand is configured to adapt to a plurality of operations of the articulated robot, and the plurality of operations include an operation of transferring a washing rack in which a dish is placeable, from one support surface to another support surface, an operation of picking up the dish and of placing the dish in the washing rack, and an operation of picking up a subrack in which the dish is placed and of placing the subrack in the washing rack.

(2) In the hand, it is preferable that a holding portion that has a pipeline communicating with a negative pressure generation device and that holds the dish by acting a negative pressure on the dish, the negative pressure being generated by the negative pressure generation device, and an abutting member that is abuttable against the washing rack are provided, and it is preferable that an engagement portion that is engageable with the subrack is formed in the abutting member.

(3) In the hand, it is preferable that the holding portion is linearly movable between a first position and a second position, and it is preferable that an elastic member that biases the holding portion toward the first position and a detection unit that detects a movement of the holding portion from the first position to the second position are further provided.

(4) In the hand, it is preferable that the detection unit optically detects the movement.

(5) In the hand, it is preferable that the holding portion includes a filter in the pipeline.

(6) In the hand, it is preferable that the subrack includes a main body portion, a shaft portion standing at a position of a center of gravity of the main body portion, and an arm portion extending in a horizontal plane so as to intersect the shaft portion, it is preferable that the arm portion has a substantially rectangular cross-sectional shape when cut perpendicularly to an extending direction of the arm portion and one of diagonal lines of the substantially rectangular shape extends in a vertical direction, and it is preferable that the engagement portion has two engagement surfaces that are abuttable against two side surfaces of the arm portion that are related to two sides of the substantially rectangular shape.

(7) There is provided a hand that is mountable in an articulated robot for a dishwashing system, the hand including: a holding portion that is linearly movable between a first position and a second position and that holds a dish using a negative pressure; an elastic member that biases the holding portion toward the first position; and a detection unit that detects a movement of the holding portion from the first position to the second position.

(8) There is provided an articulated robot for a dishwashing system, in which a hand mounted at an end portion of the articulated robot includes a holding portion that is linearly movable between a first position and a second position and that holds a dish by acting a negative pressure on the dish, the negative pressure being generated by a negative pressure generation device, an elastic member that biases the holding portion toward the first position, and a detection unit that detects a movement of the holding portion from the first position to the second position.

(9) There is provided a control device that controls an articulated robot for a dishwashing system, in which a hand of the articulated robot includes a holding portion that is linearly movable between a first position and a second position and that holds a dish by acting a negative pressure on the dish, the negative pressure being generated by a negative pressure generation device, an elastic member that biases the holding portion toward the first position, and a detection unit that detects a movement of the holding portion from the first position to the second position. While the articulated robot in which the hand is mounted operates to pick the dish, when the detection unit detects the operation, the control device stops the operation of the articulated robot.

In addition, another aspect of the above-described embodiment provides the following solutions. In this case, a configuration that facilitates collaboration between a robot and a person (worker) can be realized.

(1a) There is provided a dishwashing system including: an articulated robot supported on a wall disposed in a vertical direction; and a control device that controls the articulated robot to realize washing of a dish.

(2a) In the dishwashing system, it is preferable that the articulated robot is capable of performing an operation related to a washing rack in which the dish is placeable.

(3a) In the dishwashing system, it is preferable that the operation related to the washing rack includes at least one of an operation of transferring the washing rack from one support surface to another support surface, an operation of picking up the dish and of placing the dish in the washing rack, an operation of picking up a subrack in which the dish is placed and of placing the subrack in the washing rack, and an operation of picking up the dish from inside the washing rack and of placing the dish on a placement portion.

(4a) In the dishwashing system, it is preferable that the articulated robot includes a first robot and a second robot, it is preferable that the control device causes the first robot to operate to place the dish in the washing rack on a first support surface and to transfer the washing rack on the first support surface to a second support surface, and it is preferable that the control device causes the second robot to operate to transfer the washing rack on the second support surface to a third support surface, to pick up the dish in the washing rack on the third support surface, to place the picked-up dish on a placement portion, and to transfer the washing rack on the third support surface to the first support surface.

(5a) In the dishwashing system, it is preferable that the third support surface is provided by a removable table or a storable table.

(6a) In the dishwashing system, it is preferable that a protrusion amount of the articulated robot from the wall when the articulated robot is in a retracted posture in a top view is smaller than a size of the washing rack in a lateral direction.

According to one aspect, a configuration that facilitates collaboration between a robot and a person (worker) can be realized.

### REFERENCE SIGNS LIST

1 Control device for a dishwashing system

4 Dishwasher

5A Hand

5B Hand

11 Processing device

12 Image processing device

21 First robot

22 Second robot

23 First camera

24 Second camera

26 Spraying device

27 Rotating device

28A Negative pressure generation device

28B Negative pressure generation device

51 Abutting member

56 Holding portion

61 Engagement portion

72A Detection unit

72B Detection unit

110 Main body portion

120 Shaft portion

121 Arm portion

122a Engagement surface

122b Engagement surface

R Washing rack

SR Subrack

1. A control device for a dishwashing system, the control device comprising:
processing circuitry configured to
control an operation of a work device that performs an operation related to a washing rack that is placeable on each of a plurality of support surfaces extending in substantially the same plane, wherein the plurality of support surfaces include a first support surface, a second support surface disposed in association with a dishwasher capable of washing a dish in the washing rack, and a third support surface; and
control the work device to operate such that the washing rack is transferred from the first support surface and to be returned to the first support surface via the second support surface and via the third support surface, wherein
a direction in which the washing rack is carried into the dishwasher and a direction in which the washing rack is carried out of the dishwasher form a substantially right angle as viewed from above.

2. The control device according to claim 1, wherein a direction in which the washing rack is transferred from the first support surface to the second support surface and a direction in which the washing rack is transferred from the third support surface to the first support surface form a substantially right angle as viewed from above.

3. The control device according to claim 1, wherein the processing circuitry is further configured to control the work device to place the dish in the washing rack on the first support surface, to pick up the dish in the washing rack on the third support surface and to place the dish on a placement portion.

4. The control device according to claim 1, wherein
the work device includes a first robot and a second robot, and
the processing circuitry is further configured to
control the first robot to place the dish in the washing rack on the first support surface, and to transfer the washing rack on the first support surface to the second support surface, and
control the second robot to transfer the washing rack on the second support surface to the third support surface, to pick up the dish in the washing rack on the third support surface, to place the picked-up dish on a placement portion, and to transfer the washing rack on the third support surface to the first support surface.

5. The control device according to claim 4, wherein each of the first robot and the second robot is controlled to pick-up and place the dish by a direct pick-up and placement of the dish or by a pick-up and placement of a subrack in which the dish is placed.

6. The control device according to claim 5, further comprising:
an image processing device configured to process an image obtained by a camera that captures an image of a state on a table on which the dish before washing is placeable, to recognize the dish on the table, wherein
the processing circuitry is further configured to control the first robot to place a first-class dish in the washing rack on the first support surface without using the subrack, and to place a second-class dish in the washing rack using the subrack, based on a recognition result of the image processing device.

7. The control device according to claim 6, wherein the processing circuitry is further configured to control the first robot to place the first-class dish in the washing rack on the first support surface after a preliminary washing process is executed on the first-class dish by a washing device, based on the recognition result of the image processing device.

8. The control device according to claim 7, wherein the preliminary washing process includes at least one of a process of spraying a washing liquid or water toward the dish and a process of physically rubbing a washing member against the dish.

9. The control device according to claim 4, wherein
the plurality of support surfaces further include a fourth support surface,
the first support surface, the third support surface, and the fourth support surface each have a region corresponding to an outer shape of the washing rack, and
the processing circuitry is further configured to control the second robot to transfer the washing rack on the second support surface to the fourth support surface, and then to transfer the washing rack to the third support surface.

10. The control device according to claim 9, wherein
the first support surface is adjacent to the second support surface and the fourth support surface is adjacent to the third support surface, and
a direction in which the washing rack is transferred from the second support surface to the fourth support surface and a direction in which the washing rack is transferred from the fourth support surface to the third support surface form a substantially right angle as viewed from above.

11. The control device according to claim 9, wherein
a direction in which the washing rack is transferred from the second support surface to the fourth support surface is substantially parallel and opposite to a direction in which the washing rack is transferred from the third support surface to the first support surface, and
a direction in which the washing rack is transferred from the fourth support surface to the third support surface is substantially parallel and opposite to a direction in which the washing rack is transferred from the first support surface to the second support surface.

12. The control device according to claim 9, wherein the first support surface, the second support surface, the third support surface, and the fourth support surface are in contact with a bottom surface of the washing rack to support the washing rack.

13. The control device according to claim 12, wherein the work device transfers the washing rack such that the washing rack continuously travels a plurality of times on a series of support surfaces including the first support surface, the second support surface, the third support surface, and the fourth support surface.

14. The control device according to claim 9, wherein the work device pushes an outer or inner surface of the washing rack to transfer the washing rack from the first support surface to the second support surface, from the second support surface to the fourth support surface, from the fourth support surface to the third support surface, and from the third support surface to the first support surface.

15. The control device according to claim 4, wherein each of the first robot and the second robot is an articulated robot and is installed on a wall at a height separated from a floor surface.

16. The control device according to claim15, wherein
at least one hand of the first robot and the second robot is configured to perform a plurality of operations of the articulated robot, and
the plurality of operations include a first operation of transferring the washing rack from one support surface of the plurality of support surfaces to another support surface, a second operation of picking up the dish and placing the dish in the washing rack, and a third operation of picking up a subrack in which the dish is placed and placing the subrack in the washing rack.

17. The control device according to claim 1, wherein the third support surface is provided by a removable table or a storable table.

18. A non-transitory computer readable medium storing computer executable instructions which, when executed by processing circuitry of a dishwashing system, cause the processing circuitry to execute a process comprising:
control an operation of a work device that performs an operation related to a washing rack that is placeable on each of a plurality of support surfaces extending in substantially the same plane, wherein the plurality of support surfaces include a first support surface, a second support surface disposed in association with a dishwasher capable of washing a dish in the washing rack, and a third support surface; and
control the work device to operate such that the washing rack is transferred from the first support surface and to be returned to the first support surface via the second support surface and via the third support surface, wherein
a direction in which the washing rack is carried into the dishwasher and a direction in which the washing rack is carried out of the dishwasher form a substantially right angle as viewed from above.

19. A dishwashing system, comprising:
a control device;
a first support portion having a first support surface capable of supporting a washing rack;
a second support portion having a second support surface capable of supporting the washing rack, the second support portion being provided with a dishwasher capable of washing a dish in the washing rack supported on the second support surface;
a third support portion having a third support surface capable of supporting the washing rack; and
a work device that is controllable by the control device, wherein
the first support surface, the second support surface, and the third support surface extend in substantially a same plane,
the work device is operable such that the washing rack is transferred from the first support surface to be returned to the first support surface via the second support surface and via the third support surface, and
a direction in which the washing rack is carried into the dishwasher and a direction in which the washing rack is carried out of the dishwasher form a substantially right angle as viewed from above.

20. The dishwashing system according to claim 19, wherein the control device includes processing circuitry configured to control operation of the work device such that the washing rack is transferred from the first support surface and to be returned to the first support surface via the second support surface and via the third support surface.
